(19) United States
(12) Patent Application Publication
(10) Pub. No.: US 2002/0062334 A1
(43) Pub. Date: May 23, 2002

(54) DYNAMIC AGENTS FOR DYNAMIC SERVICE PROVISION

(76) Inventors: QIMING CHEN, SUNNYVALE, CA (US); PARVATHI CHUNDI, MOUNTAIN VIEW, CA (US); UMESHWAR DAYAL, SARATOGA, CA (US); MEICHUN HSU, LOS ALTOS HILLS, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/136,768

(22) Filed: Aug. 19, 1998

(51) Int. Cl. G06F 15/16

(52) U.S. Cl. 709/200

(57) ABSTRACT

Dynamic agents and a dynamic agent infrastructure (platform) that provides a shift from static distributed computing to dynamic distributed computing are provided. The infrastructure supports dynamic behavior modification of agents. For example, a dynamic agent is not designated to have a fixed set of predefined functions but, instead, to carry application specific actions, which can be loaded and modified on the fly. Dynamic behavior modification allows a dynamic agent to adjust its capability for accommodating environment and requirement changes, and to play different roles across multiple applications. These features are supported by the light-weight, built-in management facilities of dynamic agents, which can be commonly used by the “carried” application programs to communicate, manage resources, and modify their problem solving capabilities. Accordingly, an infrastructure is provided for application specific multi-agent systems that provides “nuts and bolts” for run-time system integration and supports dynamic service construction, modification, and movement.

### CROSS-REFERENCE TO COMPUTER LISTING APPENDIX

Appendix A includes a listing of a computer program, in accordance with one embodiment of the invention, that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention relates to distributed computing and, in particular, to dynamic agent computing.

2. Related Art

Distributed problem solving is characterized by decentralization and cooperation. The term decentralization is used to indicate that the task is handled by multiple distributed autonomous agents without global control. The term cooperation is used to indicate that the task is accomplished by those agents through information exchange and task sharing as no one agent has sufficient information to solve the entire problem. To support distributed problem solving, various multi-agent systems have been developed.

In most existing agent systems, an agent's behavior is fixed at the time the agent is created. To change behavior, the agent must be completely replaced by another agent. Mobile agents can move close to each other for reducing communication cost but can only perform predefined and statically coded actions.

### SUMMARY OF THE INVENTION

However, in cooperative work, it is important for a participating agent to play different roles while maintaining its identity and consistent communication channels, as well as retaining data, knowledge, and other system resources. Accordingly, a software agent should have the capability of partially changing its behavior while executing (i.e., dynamic behavior), rather than being completely replaced by another agent.

In one embodiment, to support dynamic behavior, software agents have the following capabilities: distributed communication; mobility; dynamically loading, tuning, and executing actions; persistence for storing data objects and program objects to be used across multiple applications; and resource management facilities for managing data and program objects.

In one embodiment, a dynamic agent infrastructure is provided. The infrastructure is Java™-coded, platform-neutral, light-weight, and extensible. The infrastructure supports dynamic behavior modification of agents. Dynamic agents are general purpose containers of programs, rather than individual and application specific programs. All the newly created dynamic agents are the same; application specific behaviors are gained and modified by dynamically loading Java™ classes representing data, knowledge, and application programs. A dynamic agent is provided with light-weight, built-in management facilities for distributed communication, for storing programs and data, and for maintaining knowledge, which can be commonly used by the application programs to communicate and cooperate with other agents. Accordingly, the dynamic agent infrastructure is designed to make it easier to develop autonomous software agents with modifiable behaviors, to construct, modify, and move services dynamically, without shutdown/restart, and to retool clients by loading new programs on the fly (dynamically). In this way, the infrastructure greatly simplifies the deployment of application specific, cooperative multiagent systems.

### BRIEF DESCRIPTION OF THE DRAWINGS

The foregoing and other aspects and advantages of the present invention will become apparent from the following detailed description with reference to the drawings, in which:

FIG. 1 is a block diagram of exemplary hardware in accordance with one embodiment of the present invention.

FIG. 2 is a block diagram of a dynamic agent in accordance with one embodiment of the present invention;

FIG. 3 is a functional diagram of the dynamic agent of FIG. 2 being modified dynamically by loading a Java™ class in accordance with one embodiment of the present invention;

FIG. 4 is a block diagram of a dynamic agent shown in greater detail in accordance with one embodiment of the present invention;

FIG. 5 is a functional diagram of a dynamic agent factory for cloning dynamic agents in accordance with on embodiment of the present invention;

FIG. 6 is a flow diagram of an execution of cloning a dynamic agent in accordance with one embodiment of the present invention;

FIG. 7 is a functional diagram of a coordinator dynamic agent for coordinating dynamic agents in accordance with one embodiment of the present invention;

FIG. 8 is a functional diagram of dynamic service provision in accordance with one embodiment of the present invention;

FIG. 9 is a block diagram of a resource broker dynamic agent in accordance with one embodiment of the present invention;

FIG. 10 is a block diagram of a request broker dynamic agent in accordance with one embodiment of the present invention;

FIG. 11 is a block diagram of an event broker dynamic agent in accordance with one embodiment of the present invention;

FIG. 12 is a functional diagram of dynamic agent groups with a local coordinator in accordance with one embodiment of the present invention; and

FIG. 13 is a block diagram of dynamic agents for real-time manufacturing process scheduling and checking in accordance with one embodiment of the present invention.

### DETAILED DESCRIPTION OF THE INVENTION

Distributed computing systems can be constructed in two fundamentally different ways: statically or dynamically.

### Interface-based Distributed Computing: Static

Statically configured computing systems typically have the following characteristics.

### Fixed Locations

Services are configured at “well-known” locations, and invoked through client/server connections, even if the use of CORBA (Common Object Request Broker Architecture), DCE (Distributed Computing Environment), or RMI (Remote Method Invocation) makes such invocation transparent. The location of a service can be changed by modifying a service registry. By contrast, message enabling at run-time does not support this function.

### Predefined Functionalities

A server, as an object, has a fixed set of functions. In a remote invocation-based infrastructure such as CORBA, DCOM, RMI, or DCE, the functions can be invoked through the server object's interface The interface must be pre-specified in terms of an interface language, such as IDL (Interface Definition Language), and the server object essentially implements the interface. From a client's point of view, such an “interface-based” server has predefined behavior.

### Stationary Service

Service providers are not mobile in the sense that the implementation of an interface may not necessarily be portable or movable. The remote function invocation mechanisms are generally based on data flow, namely, sending requests to and requesting results from servers at fixed locations. The flow of programming objects is not supported. Further, because a service provider is statically registered to the distributed computing infrastructure such as DCE and CORBA; once moved, the service provider can become a dangling object.

A statically configured distributed computing framework is useful in many applications. However, a statically configured distributed computing framework has significant limitations in highly dynamic cooperative problem solving. For example, highly dynamic cooperative problem solving involves self-installable and self-configurable system components to act at an appropriate time and location, to adjust their behaviors on the fly for accommodating environment changes, and to exchange program modules for cooperation.

### Agent-based Distributed Computing: Dynamic Location but Static Behavior

Dynamic service provision means that services can be constructed, modified, and moved flexibly on demand. Dynamic service provision includes the use of the system components that can be dynamically configurable and modifiable for resetting their capabilities on the fly.

Java™ programs are platform-neutral, which provides a foundation for moving not only data but also programs. For example, agent platforms that support agent communication or mobility (or both) have been developed. For example, an agent is created at one site and then “launched” to a remote site. Agent communication languages and knowledge exchange protocols, such as the well-known KQML, are available, and KQML is being incorporated with CORBA.

However, the existing agent platforms lack dynamic modifiability of behavior for the following reasons. First, a software agent, either as a server or as a client in an application, must be statically coded and launched, with predefined functionalities. For example, each agent is an object instance in that it can do only a fixed set of functionalities defined by the object class, no more, and no less. Second, the existing platforms do not support service reconstruction by “partially” changing agents' behaviors: a mobile agent must bring all its capabilities to travel. Third, agents lack data, knowledge, and program management facilities to support dynamic behavior and cooperation.

### Dynamic Agents: an Agent Platform

Accordingly, an agent platform for dynamic service provision (e.g., with dynamic modifiability of behavior) is provided in accordance with one embodiment of the present invention. An agent platform includes dynamic agents that load, carry, manage, and execute application specifications. Their capabilities are modifiable by changing the data and program objects they carry and instantiate. Their cooperation is established by, for example, message-enabled exchange of data, knowledge, programs, and state information.

Unlike application specific agents, dynamic agents are generic when they are created. Problem solving capabilities are gained by dynamically loading Java™ classes representing data, knowledge, and application programs, as well as modified in the same way. Dynamic agents also include built-in management capabilities for handling resources and actions, as well as the persistence of data, knowledge, and action objects over the agent's lifetime, which allows them to be used across multiple applications.

In comparison with “interface-based” and “static-behavioral” remote invocation infrastructures, a dynamic agent is not an object interface referring to a fixed set of functions. Rather, a dynamic agent can be viewed as a dynamic interface. With dynamic agents, services can be configured and modified on the fly (dynamically).

In comparison with existing agent frameworks, which support mobility but not behavior modification, dynamic agents can update their functionalities flexibly after they are launched. Also, a dynamic agent changes its functionality by changing the use of its carried resources, and thus, the dynamic agent can maintain consistent identity and communication channels during cooperative work. Moreover, the change of a dynamic agent's behavior can be made partially based on need, which avoids the cost of moving the whole agent around. Finally, the data, knowledge, and program management facilities of dynamic agents, which can be used by any carried actions, greatly simplify the development of agent-based problem solving systems.

### Exemplary Hardware

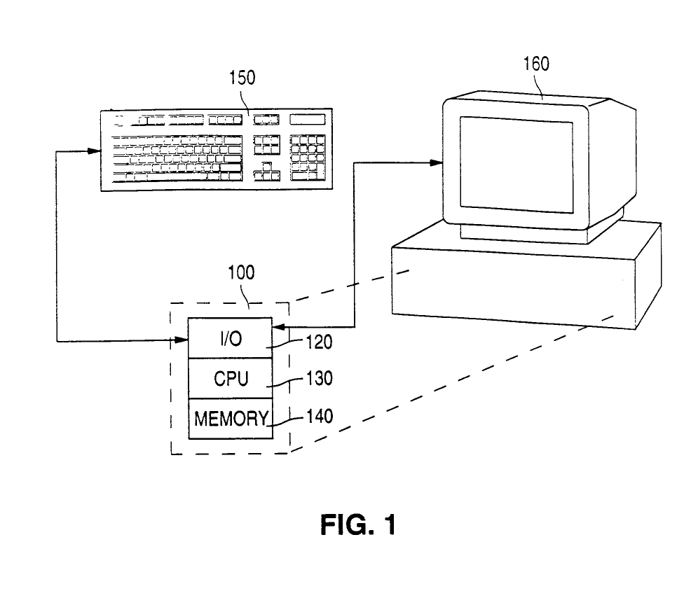

FIG. 1 illustrates a data processing system in accordance with the teachings of the present invention. FIG. 1 shows a computer 100, which includes three major elements. Computer 100 includes an input/output (I/O) circuit 120, which is used to communicate information in appropriately structured form to and from other portions of computer 100. Computer 100 includes a control processing unit (CPU) 130 in communication with I/O circuit 120 and a memory 140 (e.g., volatile and non-volatile memory). These elements are those typically found in most general purpose computers and, in fact, computer 100 is intended to be representative of a broad category of data processing devices. A raster display monitor 160 is shown in communication with I/O circuit 120 and issued to display images generated by CPU 130. Any well known variety of cathode ray tube (CRT) or other type of display can be used as display 160. A conventional keyboard 150 is also shown in communication with I/O circuit 120. It will be appreciated by one of ordinary skill in the art that computer 100 can be part of a larger system. For example, computer 100 can also be in communication with a network (e.g., connected to a local area network (LAN) or the Internet).

In particular, computer 100 can include dynamic agent circuitry for dynamic service provision in accordance with the teachings of the present invention, or as will be appreciated by one of ordinary skill in the art, the present invention can be implemented in software stored in and executed by computer 100. For example, a dynamic agent, stored in memory 140, can be executed on CPU 130, in accordance with one embodiment of the present invention.

### Dynamic Agents

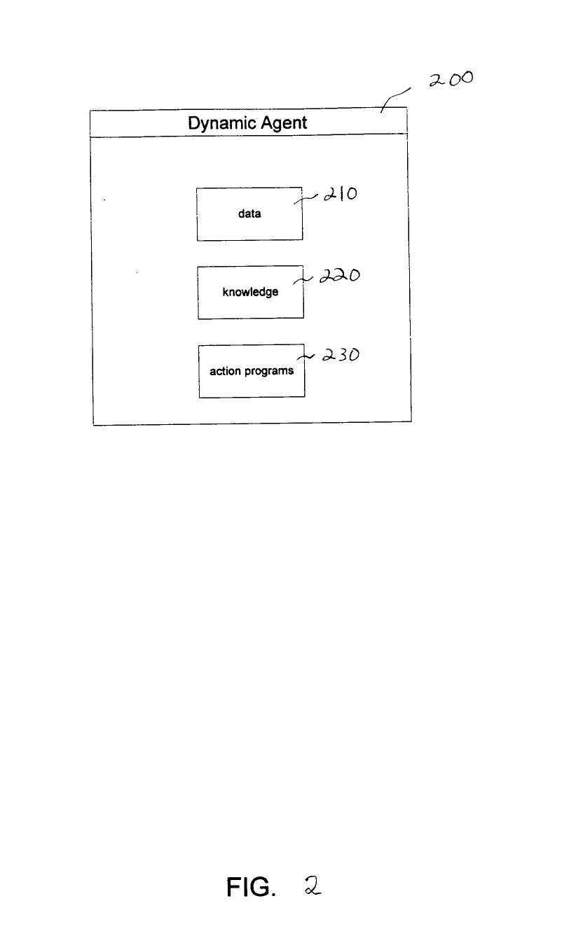

FIG. 2 is a block diagram of a dynamic agent 200 in accordance with one embodiment of the present invention. Dynamic agent 200 is a Java™-coded, autonomous, message-driven system with a built-in object store and several light-weight management facilities, as well as a GUI to enable user interaction, which form the fixed part (portion) of the dynamic agent. The dynamic agent's modifiable portion includes its data 210; knowledge 220, and action programs 230, which determines its application specific capabilities. The generic, fixed portion of a dynamic agent, together with its application programs, acts as an autonomous, problem solver.

### Dynamic Agent Architecture

### Action Carrying Capability

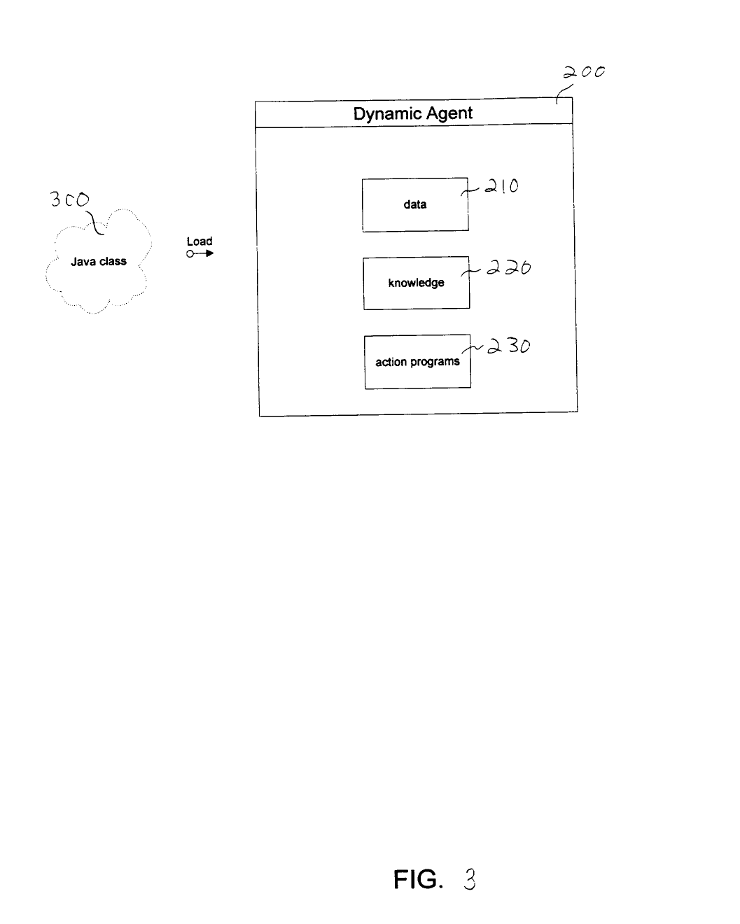

FIG. 3 is a functional diagram of the dynamic agent of FIG. 2 being modified dynamically by loading a Java™ class in accordance with one embodiment of the present invention. Dynamic agents include the same structure: their application specific behaviors are gained and modified by dynamically loading a Java™ class 300 representing data, knowledge, and application programs. Upon receipt of corresponding messages or API invocation, a dynamic agent can load, store, retrieve, instantiate, and execute the carried program, and within the program, built-in functions can be used to access the dynamic agent's resources, activate other actions, and communicate with other dynamic agents.

### Management Capability

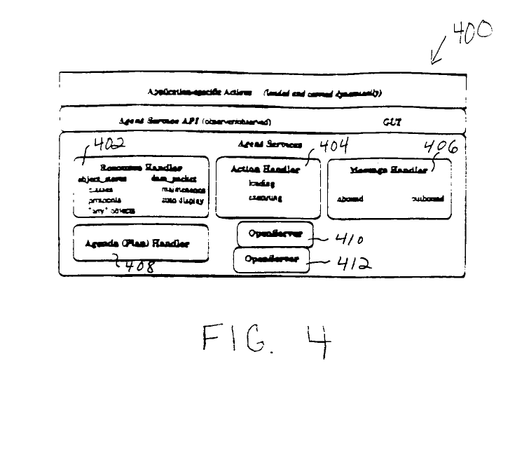

FIG. 4 is a block diagram of a dynamic agent 400 shown in greater detail in accordance with one embodiment of the present invention. Dynamic agent 400 is provided with light-weight management capabilities for distributed communication, action handling, program storage, and knowledge maintenance, which can be used by the “carried” application programs. Dynamic agent 400 includes a message handler 406 for managing message queues, sending, receiving, and interpreting inter-agent messages. The interaction styles include one way, request/reply, and publish/subscribe (e.g., selective broadcast). Message forwarding can also be provided.

Dynamic agent 400 includes an action handler 404 for handling the message-enabled instantiation and execution of application programs (e.g., Java™ classes). Dynamic agent 400 can carry multiple action programs.

Dynamic agent 400 includes open server handlers 410 and 412. Open servers provide a variety of continuous services, such as automatically processing any message or data record put into a specified network location. Such “daemon-like” services can be started and stopped flexibly at dynamic agent run-time.

Dynamic agent 400 includes an agenda handler 408 for instantiating and executing agenda objects. An agenda object represents a list of sequential, concurrent, or conditional tasks to be executed by the same dynamic agent. However, a task can be sent as a request to another agent, and in this way, the agenda can involve other agents.

Dynamic agent 400 includes a resource handler 402 for maintaining an object store for the dynamic agent. The object store includes application specific objects that can be, for example, data packets (e.g., named value lists), rules, agendas, Java™ classes, and instances including language interpreters, addresses and any objects, namely, instances of any class.

Applications executed within a dynamic agent use the built-in dynamic agent management services to access and update application specific data in the object store, and to perform inter-agent communication through messaging. An action, when started, is offered a reference to the underlying built-in management facilities, and the action can use this reference to access the APIs of the services. This, in turn, simplifies the development of the carried applications and enhances the dynamic agent's ability to cooperate with other dynamic agents.

### Mobility

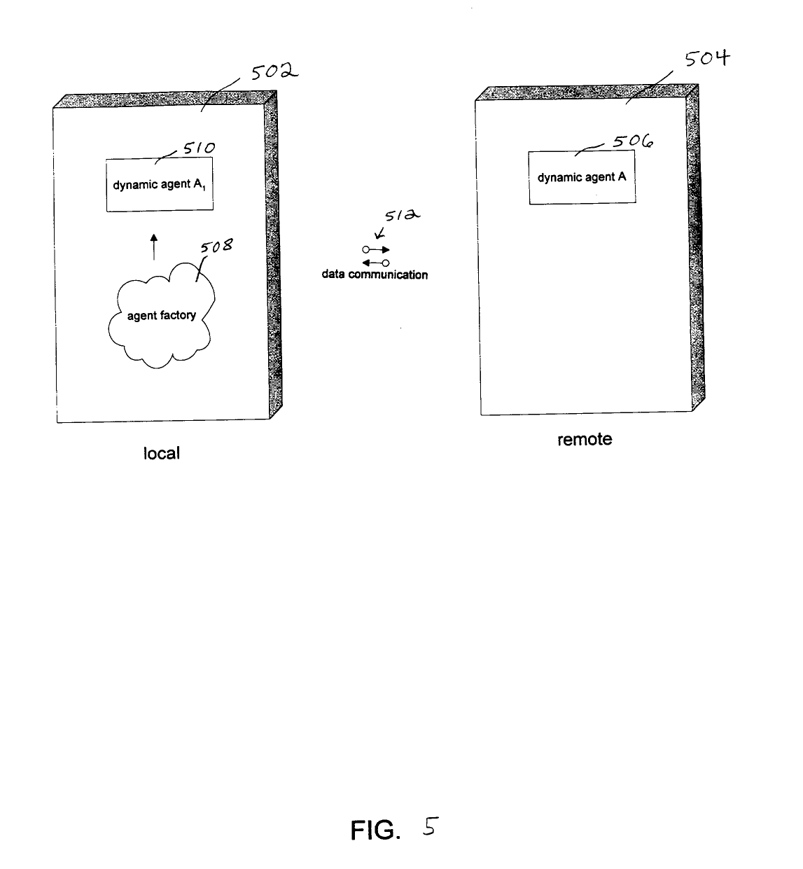

In one embodiment, mobility is provided both at the dynamic agent level and at the action level. FIG. 5 is a functional diagram of a dynamic agent factory for cloning dynamic agents in accordance with on embodiment of the present invention. Dynamic agents, such as dynamic agent A₁ 510 at a local site 502, which is a clone of dynamic agent A 506 at a remote site 504, are created by a system referred to as an agent factory 508 executing on local site 502. Dynamic agents can be launched (via a data communication 512) or cloned at a remote site by sending requests to the agent factory installed on that site. A clone can be made with the options of removing or not removing the original agent, which is logically equivalent to moving or copying the original agent, respectively.

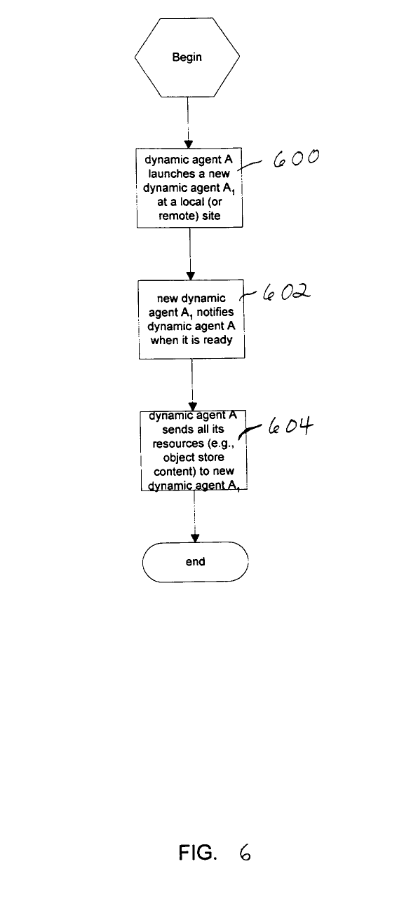

FIG. 6 is a flow diagram of an execution of cloning a dynamic agent in accordance with one embodiment of the present invention. A dynamic agent A clones itself by executing the following stages of operation. At stage 600, dynamic agent A launches a new dynamic agent A₁ at a local or remote site. At stage 602, new dynamic agent A₁ notifies dynamic agent A when it is ready. At stage 604, dynamic agent A then sends all its resources (e.g., object-store content) to new dynamic agent A₁. During the cloning operation, a message forwarder of the original dynamic agent A is responsible for receiving and forwarding incoming messages, ensuring that no messages are lost.

Further, because the dynamic agent infrastructure supports program flow, dynamic agents can exchange program objects with each other, in the same way as exchanging data objects. For example, the programs or knowledge modules carried by the dynamic agents are movable on the Internet.

Accordingly, the first level of mobility, cloning agents, reduces bandwidth consumption. The second level of mobility, moving program objects, provides added flexibility, dynamic system reconstruction, and integration.

### Coordination

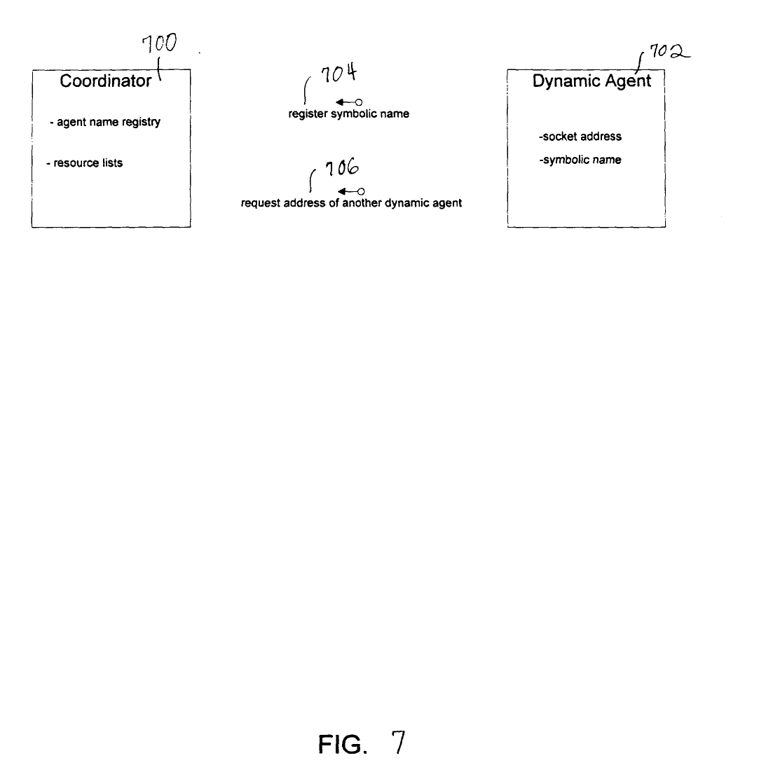

FIG. 7 is a functional diagram of a coordinator dynamic agent 700 for coordinating dynamic agents in accordance with one embodiment of the present invention. A dynamic agent 702 is uniquely identified by its socket address (network address) (e.g., “mymachine@hpl.hp.com:7000”). Dynamic agent 702 is also given a unique symbolic name. Coordinator 700 provides a naming service. Coordinator 700 is a dynamic agent that maintains an agent name registry and, optionally, resource lists. For example, when dynamic agent 702 is created, dynamic agent 702 will first attempt to register its symbolic name and address with coordinator 700. Thereafter, dynamic agent 702 can communicate with other dynamic agents by name. When dynamic agent 702 needs to send a message to another dynamic agent whose address is unknown, dynamic agent 702 consults coordinator 700 to obtain the address via a message 706. If dynamic agent 702 is instructed to load a program but the address is not given, dynamic agent 702 consults coordinator 700 or the request sender to obtain the address. Dynamic agent 702 can also maintain an address book, recording the addresses of those dynamic agents that have become known to it and become known to be alive.

In one embodiment, dynamic agents form hierarchical groups, and each group has a coordinator agent that provides a naming service, and other optional services for cooperation, such as a resource directory service.

### Dynamic Behavior Modification

In one embodiment, while a newly born dynamic agent includes the built-in capabilities as its fixed portion, it does not include any application specific functionality upon creation. The dynamic agent's modifiable or replaceable portions, or application specific behaviors, are gained by loading local or remote programs, rules and data, or by activating open servers. Dynamic system integration supports not only the communication between dynamic agents, but also the communication between actions carried by the same dynamic agent, and between a dynamic agent and a stand-alone program.

### Actions

Applications are developed as action programs, which are, for example, Java™ programs, with arbitrary functionalities. In order for the action programs to access the agent service APIs, the action programs are wrapped by Java™ classes that implement an interface class AgentAction, supported in the class library. The resource handler has a built-in network class loader to load a Java™ program (which is a Java™ class) identified by its name and URL. The action handler can instantiate an instance of the loaded program and start its execution.

In one embodiment, two types of actions are provided. An event driven action is an action started in response to a message and then “dies” as soon as its task is finished. A daemon action is an action started upon request to provide continuous service. Additional service interfaces are provided to explicitly stop or kill a daemon action. An action running on a dynamic agent A can send messages through dynamic agent A to other dynamic agents to enable actions remotely or use either APIs or messages to start other actions locally on dynamic agent A.

### Open Servers

Open servers provide daemon-like continuous services that are not already built-in but are flexibly loaded and started at dynamic agent run-time. Open servers extend the capabilities of dynamic agents allowing the services to be flexibly configured. Thus, while the action handler is used to dynamically extend the application specific agent capabilities, the open server handler is used to dynamically extend the dynamic agent management services beyond the built-in ones.

In one embodiment, an open server is a Java™ class developed as a subclass of the OpenServer class supported in the class library and inherits capabilities to function as an agent service, including accesses to services that are not open to application programs.

Open servers are useful in environment wrapping. For example, when deploying a dynamic agent application system, exogenous signals (e.g., messages sent by programs that are not dynamic agents) and other types of exogenous information are made available to the dynamic agents. For example, in deploying a dynamic agent that analyzes requests sent to a Web Server, the requests can be forwarded by the Web Server to the dynamic agent through a CGI (Common Gateway Interface) program. An open server can be deployed in the dynamic agent to monitor the Web requests provided by the CGI program and convert the requests into a dynamic agent message to be inserted in the dynamic agent's input queue. Accordingly, the open server architecture allows the agent services to incorporate various environment wrapping functions modularly and seamlessly into the agent infrastructure.

### Dynamic Agent/Action Communication

Intra-agent communication allows a dynamic agent and the programs carried by it to exchange information, which is supported in the following way in accordance with one embodiment of the present invention.

From carried action to dynamic agent

All the carried program subclassing AgentAction and open servers subclassing OpenServer can access, through API's, the resources and management facilities of the dynamic agents that carry them. Thus, the dynamic agents can use those facilities to, for example, send messages, launch or clone dynamic agents, retrieve or update the objects in the object store (under access control), load actions to other dynamic agents through messaging, or display data through GUI.

From agent to carried action

When a dynamic agent starts an action, it passes certain information as parameters to that action. If it is necessary for the action program to get messages from that dynamic agent at run-time, the action creates a receiver thread and registers its socket address, corresponding to its instance identifier, to the dynamic agent. Built-in APIs can be provided for this functionality.

Between carried actions

When multiple actions are carried by the same dynamic agent, they can exchange information through the object store of that dynamic agent. A synchronization mechanism can be employed such that an object (representing a piece of information) may not be “reproduced” (i.e. replaced or updated) by the sending action until it is “consumed” by the receiving action.

### Dynamic Agent/Stand-alone Program Communication

In one embodiment, a specific program module named agent proxy is provided for any (non-agent Java™ ) program to communicate with a dynamic agent. When the agent proxy is invoked, it first creates a receiver thread and then sends a list of objects, together with its socket address, to a dynamic agent, and prior to a given timeout, receives a list of resulting objects from that dynamic agent. For example, this mechanism can be used to pass a document URL from a Web CGI program to a dynamic agent A to trigger a distributed data mining task involving multiple dynamic agents. The information relating to that document, such as suggestions on a related URL, is then returned from dynamic agent A and conveyed to the URL. The agent proxy is a ready-made, easy-to-use system component. This approach provides a convenient way of using dynamic agents as “nuts and bolts” for dynamic system integration.

### Mechanisms to Trigger Modification of Agent Behavior

In one embodiment, a dynamic agent A changes its behavior in the following cases.

Dynamic agent A is explicitly requested to load program or knowledge objects.

The operational situation requires dynamic agent A to change its behavior. For example, when dynamic agent A receives a message with domain specific content it cannot interpret, it will locate, possibly with the help of the coordinator or the sender, the corresponding message interpreter class, and then load this class. Similarly, when dynamic agent A receives a request to execute a problem solving program that it does not know about, it will ask the requester, coordinator, or resource manager for its Internet address through messaging, and then load the corresponding class, create an instance, and start its execution.

Dynamic agent A is equipped (e.g., in a specific open server) with some basic intelligence to decide when and how to change its behavior based on its knowledge and the state of carried applications.

Accordingly, dynamic agents enable agent-based applications, implemented in Java™ for example, to be developed quickly. Application specific programs can be developed individually and then carried by dynamic agents for system integration.

### Dynamic Service Provision

In statically structured distributed systems, different services are provided by different stationary servers, but the introduction of dynamic agents can liberate service provisions from such a static configuration. Given the above described infrastructure that supports communication, program flow, action initiation, and persistent object storage, dynamic agents can be used as the “nuts and bolts” to integrate system components, and further such integration can be made on the fly to provide dynamic configuration of services.

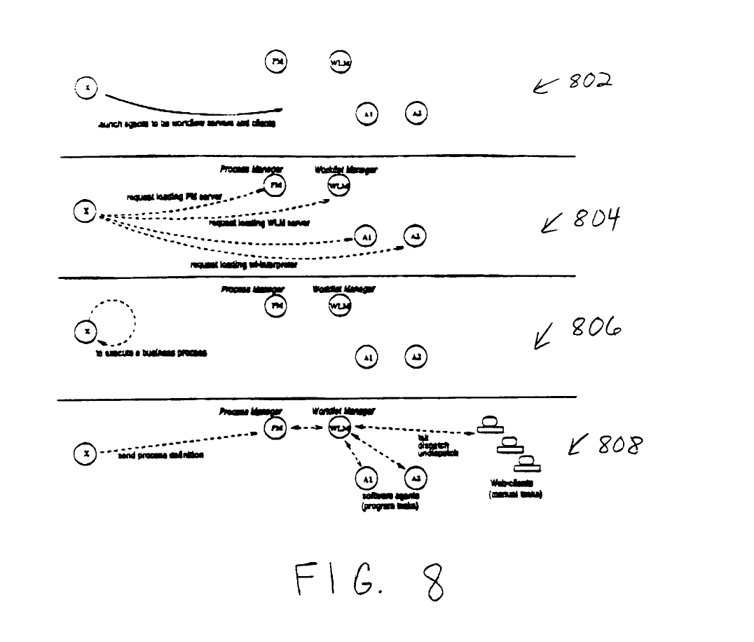

FIG. 8 is a functional diagram of dynamic service provision in accordance with one embodiment of the present invention. An application program running on dynamic agent X, generates a problem solving plan (or process) P, based on certain application logic and run-time conditions. Process P involves multiple manual and program tasks on a remote site in order to use the resources over there. The execution of process P uses two workflow servers, ProcessManager (PM) for the flow control of task, and WorkListManager (WLM) for task distribution and resulting handling. The service for executing process P is provided dynamically in the following stages of execution.

At stage 802, dynamic agent X launches dynamic agents PM, WLM on the fly to be loaded with the above workflow servers, as well as dynamic agents A1 and A2 for carrying program tasks later.

At stage 804, from dynamic agent X, messages are sent to PM, requesting it to download server ProcessManager; and to WLM, requesting it to download server WorkLis™anager from the URL specified in the messages. Further, dynamic agent X sends dynamic agents A₁ and A₂ messages, requesting each of them to download a workflow oriented message interpreter, for them to understand the work items that will be assigned to them by the WLM.

At stage 806, dynamic agent X starts process P.

At stage 808, enclosed in a message, process P is sent to the ProcessorManager executing on PM; tasks are then sent to the WorkLis™anager executing on WLM in order; work items are generated by the WorkLis™anager where manual tasks are sent to users (via a Web browser), program tasks are sent to dynamic agents A1 and A2 (requesting them to download task-oriented programs first and then execute them); execution results will be sent back to ProcessManager for flow control.

Upon termination of the process, dynamic agent X can decide to terminate the workflow servers.

Accordingly, FIG. 8 illustrates the use of dynamic agents to dynamically configure a workflow service, using the mobility, behavior-modifiability and cooperation among dynamic agents provided by this configuration. An extended is described further below.

### Cooperation Among Dynamic Agents

As discussed above, dynamic agents can communicate to expose their knowledge, abilities, and intentions, to present requests, and to exchange objects; they can move to the appropriate location to support high bandwidth configurations; and they can manage resources across actions. Because a dynamic agent can partially change its behavior rather than being replaced by another agent, in cooperative problem solving, the dynamic agent can also retain identity and state. Compared with moving the whole agent, such partial change also minimizes the corresponding network traffic.

Further, in one embodiment, coordination services in addition to a naming service can be provided for a group of dynamic agents to cooperate. These services can be provided either by the coordinator or by other designated dynamic agents. Dynamic agents can also team up into multilevel problem solving groups, called agent domains.

### Resource Broker

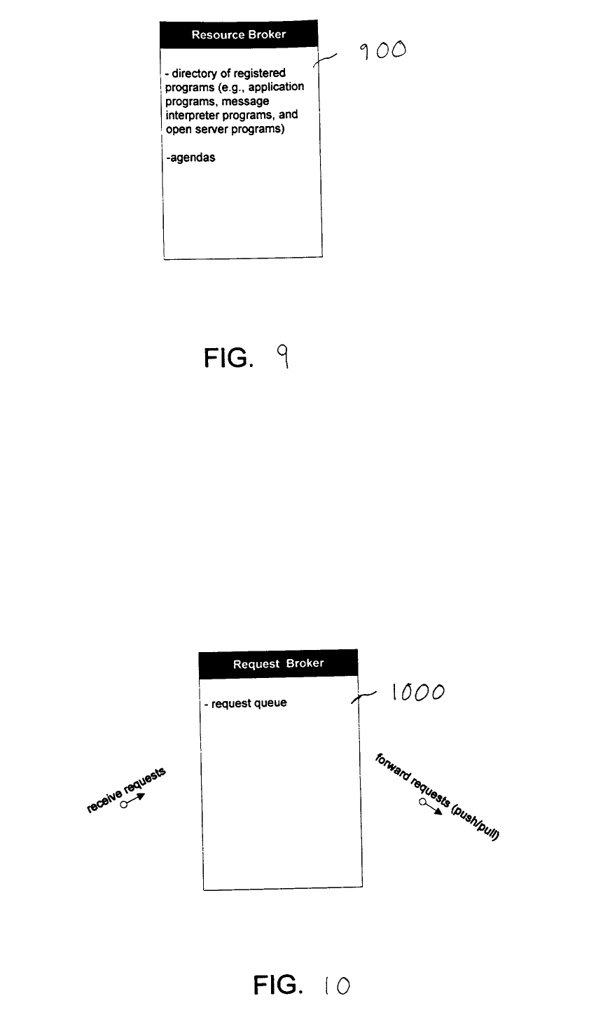

FIG. 9 is a block diagram of a resource broker dynamic agent 900 in accordance with one embodiment of the present invention. Resource broker 900 is a dynamic agent providing ‘global’ resource management service. Resource broker 900 maintains a directory of registered programs (e.g., application programs, message interpreter programs, and open server programs) and agendas. This directory maps each program name to its address (e.g., a URL). For example, when a dynamic agent A receives a request to execute a program that does not exist in its object store and its URL is unknown, dynamic agent A consults the resource broker to obtain the program's address and load the program. The coordinator can be used as a resource broker as well.

### Request Broker

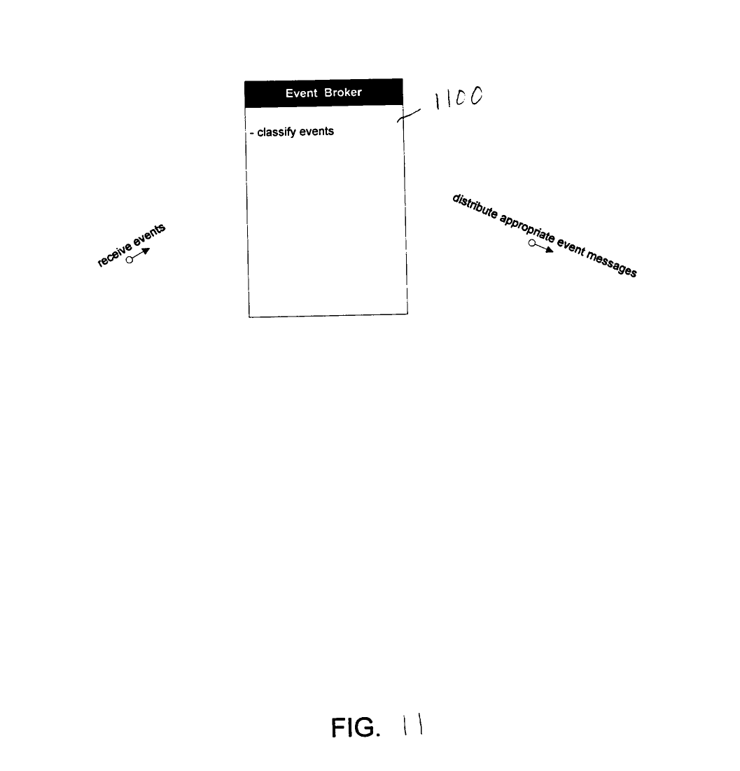

FIG. 10 is a block diagram of a request broker dynamic agent 1000 in accordance with one embodiment of the present invention. Request broker 1000 is used to isolate the service requesters from the service providers (e.g., dynamic agents that carry the services) allowing an application to transparently make requests for a service. For example, when an application carried by a dynamic agent A requests a service, it need not know who is the service provider and send the request to that provider; instead, it sends the request to request broker 1000. Request broker 1000 maintains a request queue in its object store and processes each request in an individual thread. Each request is then forwarded to the designated dynamic agent for that task, together with the address of dynamic agent A, in order to have the result sent back to dynamic agent A. Request broker 1000 interacts with service providers in two modes: push mode and pull mode. In the push mode, request broker 1000 actively sends requests to service providers. In the pull mode, request broker 1000 waits for the service provider's ask-for request and sends it a request as the reply message, which can be used for supporting redundant servers. A service provider asks for a request only when it is available, which automatically balances work load and enhances reliability. Request broker 1000 can poke those servers if a certain request is marked urgent or it receives no response after a given period of time.

Accordingly, this architecture supports seamless interaction between multiple dynamic agents in cooperative problem solving.

### Event Broker

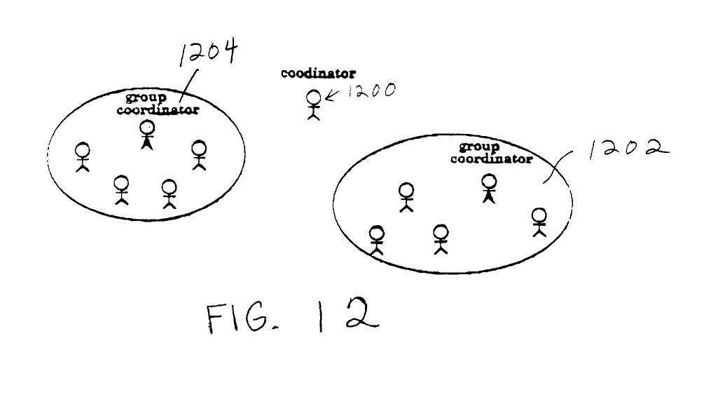

FIG. 11 is a block diagram of an event broker dynamic agent 1100 in accordance with one embodiment of the present invention. In a distributed system monitoring environment, events can be treated as asynchronous agent messages delivered to event subscribers from event generators, both of which can be dynamic agents. Event notification can be point-to-point, in which the event subscribers know the event generators and make the subscriptions accordingly; or multicast, in which one or more dynamic agents, called event brokers, are used to handle events generated anywhere, as well as event subscriptions from anywhere in the given application domain. For example, a single event broker can be used in one agent domain, which can be combined with the coordinator as well.

Event broker 1100 receives and classifies event messages sent from the event generator agents, such as system probe agents, and distributes the appropriate event messages to the registered event subscriber agents. Event distribution allows subscribing events without prior knowledge of their generators and can be arranged in multilevel agent domains.

### Dynamically Formed Agent Domain Hierarchy

In one embodiment, dynamic agents can form groups, referred to as agent domains, based on application boundaries, spatial distribution, and resource availability. An agent domain includes a coordinator for the local name service. Dynamic agents providing other kinds of coordination, such as resource broker 900, are optional.

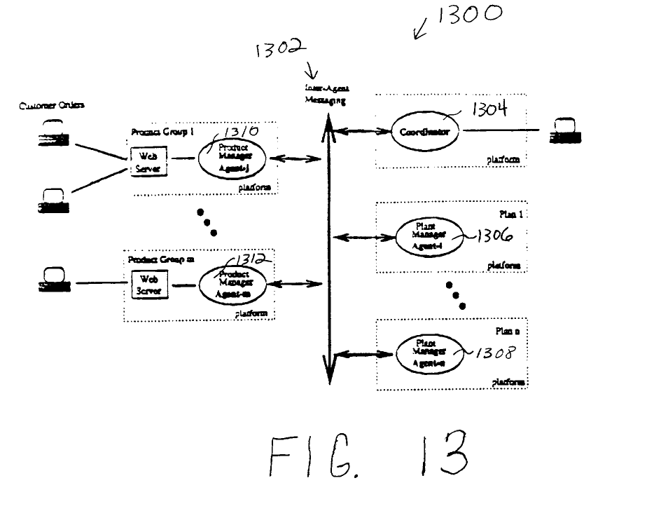

FIG. 12 is a functional diagram of dynamic agent groups with a local coordinator 1200 in accordance with one embodiment of the present invention. In a hierarchical problem solving environment, a problem is divided into multiple sub-problems to be tackled in an agent domain. The final solution of the entire problem can be generated level by level in terms of composing the solutions of the sub-problems. In this case, agent domains form a hierarchy, where a higher level coordinator provides services to lower level coordinators which in turn coordinate the agent domains at that level. In one embodiment, the following domain resolution rules apply.

Domain resolution for coordinators

The agent domain hierarchy includes a root domain whose coordinator is the one that keeps the registry of all the sub-domain coordinators (e.g., group coordinators 1202 and 1204). A coordinator at a higher level is created prior to the creation of the lower level coordinators.

Domain resolution for dynamic agents

An agent domain is uniquely identified by its coordinator, and the coordinator's name/address is registered to the higher level domain's coordinator. This information is given at the creation time of each dynamic agent. The address of a dynamic agent can include its domain path. A dynamic agent can migrate to another agent domain by loading a new coordinator's address, updating its address book, and notifying or broadcasting (through a coordinator) its change.

Domain resolution for messages or requests

A message to a dynamic agent in a foreign agent domain contains the receiver's domain path and name, and is forwarded by the coordinator of the higher level agent domain. Such forwarding can involve multiple levels. Similarly, cross-domain requests are forwarded to the request broker of the higher level agent domain. Also, agent domains, can be formed dynamically, unlike statically formed distributed computing domains, such as DCE domains.

### An Extended Dynamic Service Provision Example

Many manufacturers are increasingly relying on real-time coordination among their plants and sub-contractors to achieve timely delivery of customer orders. FIG. 13 illustrates a simplified manufacturing scheduling and tracking system 1300 based on the dynamic agent infrastructure, which coordinates a set of product groups and manufacture plants communicating via inter-agent messaging 1302, with the functions described below.

Each product group sells a number of products. A product manager dynamic agent (e.g., product manager 1310 or 1312) communicating with the Web Server is responsible for checking inventory and creating a production plan for each customer order, which involves multiple sequential or concurrent steps, or jobs for (possibly remote) manufacture plants. Subsequently, the product manager provides flow control and tracks the execution of the production plan.

For each manufacture plant, a plant manager dynamic agent (e.g., plant manager 1306 or 1308) is deployed. The plant manager is responsible for managing and utilizing the resources of that manufacture plant to do jobs assigned by different product managers. For each job, the plant manager loads or generates a secondary level work plan, which involves multiple manual and program tasks. The plant manager also interacts with the product manager to notify it of the acceptance, rejection, forwarding, and the execution status of each job. The product manager can make a replan accordingly.

A coordinator dynamic agent 1304 keeps track of the capabilities of manufacture plants and captures exceptional events, such as resource outage, exceptional congested conditions, and significant deviation from demand forecast, which are reported from plant managers and product managers. The coordinator uses the above information to make plan modification such as rerouting and makes it available to human experts to modify manufacture plant resource allocation policies. The coordinator notifies the relevant plant managers and product managers of the plan rerouting and policy changes, which in turn adapt their algorithms and resource tables.

Application programs for the above system are developed individually. The application programs can be dynamically integrated to construct or reconfigure services by using the features of dynamic agents.

The capabilities of product managers and plant managers are determined by the loaded programs, which can be updated without restating these dynamic agents. In addition, each of them can carry two servers, ProcessManager and WorkLis™anager product manager, uses these servers to handle production plans, and the plant manager uses them to handle work plan. The communications between these system components are supported by the dynamic agents.

The plant manager executes the track plan action upon completing a stage of a production plan. It employs a filtering rule to determine if replacing is needed. The trigger condition is expressed as some combination of required rework, slack time available, and the knowledge of the following: current conditions of the down stream manufacture plants; if satisfied, the product manager changes the remaining part of the plan and executes the modified plan. To perform the track plan, the knowledge of the manufacture plant conditions is dynamically updated, and the filtering rule can be dynamically altered by switching to a new track plan action program. For example, to accommodate requirement changes (e.g., order amendment or withdraw) or environment changes (e.g., plant overloaded or malfunction), and policy changes, different programs can be activated or loaded to handle rerouting, job forwarding, etc. Using dynamic agents allows these system components to play different roles in different situations, without having to be replaced by other agents. Therefore, along with behavior modification, they are able to maintain consistent identifiers and communication channels.

For example, for each manufacture plant, temporary dynamic agents can be launched to carry program tasks specified in work plans. The coordinator dynamically launches new plant managers as new manufacture plants brought on line. The coordinator notifies all existing plant managers, and they will dynamically gain the ability to communicate with the new plant managers.

Existing distributed object-oriented infrastructures such as CORBA only provide stationary services. Existing mobile agent infrastructures support agents that have a fixed set of application specific functions. Such infrastructures lack support for dynamic behavior and program level (rather than agent level) mobility.

In contrast, merging information flow and program flow to develop software agents with dynamically modifiable capabilities is provided in accordance with one embodiment of the present invention. Also, it is observed that such agents need certain core system support functions, and it is impractical to develop such support functions from scratch for each application specific agent. Thus, the above described dynamic-agent infrastructure has provided a solution to the above problems.

In one embodiment, a dynamic agent is provided with the above core system functions that allow it to carry application specific capabilities and to change them on the fly. This approach represents a shift from static to dynamic distributed computing and is suitable for highly dynamic service provision. Dynamic agents also have a higher degree of autonomy and comparability than other existing types of agents. Dynamic agents can change their problem solving capabilities to handle multiple tasks while retaining identity; they can support mobility not only at the agent level, but also at the program module level; and they can manage data, knowledge, and action objects to provide persistence across multiple applications. From the object-oriented point of view, dynamic agents are “instances” of the same class; however, their application specific behaviors are not pre-defined in that class. Those capabilities are acquired and can be used dynamically. From the software engineering point of view, the notion of “software carrier” can greatly reduce the system development cycle. While this infrastructure itself does not dwell on application specific tasks, it makes it easier to develop and deploy autonomous, adaptive, and mobile software agents to carry out those tasks and to cooperate dynamically.

Although particular embodiments of the present invention have been shown and described, it will be obvious to those skilled in the art that changes and modifications can be made without departing from the present invention in its broader aspects. For example, dynamic agents and agent services that support dynamic agents can be implemented in a variety of programming languages and programming techniques, such as object-based programming techniques using the well-known Java™ programming language, the well-known C programming language, the well-known C++ programming language, or any combination thereof. Therefore, the appended claims are to encompass within their scope all such changes and modifications that fall within the true scope of the present invention. Java™ is a trademark of Sun Microsystems, Inc. of Mountain View, Calif.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A distributed computing system comprising:
a dynamic agent infrastructure providing an environment for dynamic agents; and
a first dynamic agent executing on a first computer, wherein the first dynamic agent can be dynamically modified, and the first dynamic agent comprises management facilities for maintaining knowledge for communication and cooperation with other dynamic agents.

2. The apparatus of claim 1, further comprising:
a second dynamic agent executing on a second computer, the second dynamic agent exchanging data, knowledge and action objects with the dynamic agent service on the first computer using a message transmitted via a data communication network.

3. The apparatus of claim 2, wherein the agent infrastructure further comprises:
an agent factory executing on the second computer, the agent factory creating the second dynamic agent as a clone of the first dynamic agent.

4. The apparatus of claim 1, wherein the dynamic agents further comprise:
an action handler, an agenda handler, a message handler, an open server handler, and a resource handler.

5. The apparatus of claim 1, wherein the dynamic agents further comprise:
a network address; and
a symbolic name, wherein the network address and the symbolic name uniquely identify the dynamic agent.

6. The apparatus of claim 1, wherein the dynamic agents are modified by dynamically loading application specific programs.

7. The apparatus of claim 6, wherein the application specific programs comprise a Java™ class, and the dynamic agents further comprise built-in management services, the built-in management services being used to access resources of the dynamic agents, to activate actions to be performed by the dynamic agents, and to communicate with other dynamic agents.

8. The apparatus of claim 1, wherein the agent infrastructure further comprises:
a coordinator dynamic agent executing on a computer connected to the data communications network, the coordinator dynamic agent maintaining an agent name registry and a resource list.

9. The apparatus of claim 1, wherein the agent infrastructure further comprises:
a resource broker dynamic agent executing on a computer connected to the data communications network, the resource broker dynamic agent maintaining a directory of registered programs.

10. The apparatus of claim 1, wherein the agent infrastructure further comprises:
a request broker dynamic agent executing on a computer connected to the data communications network, the request broker dynamic agent maintaining a request queue.

11. The apparatus of claim 1, wherein the agent infrastructure further comprises:
an event broker dynamic agent executing on a computer connected to the data communications network, the event broker dynamic agent classifying events.

12. The apparatus of claim 1, wherein the agent infrastructure is implemented in a Java™ programming language.

13. The apparatus of claim 1 wherein a dynamic agent further comprises: a Java™ class, the Java™ class comprising data, knowledge, and application specific programs.

14. The apparatus of claim 1 wherein the agent infrastructure provides inter-agent messaging.

15. The apparatus of claim 2 wherein the second dynamic agent transmits a service/resource request message to the first dynamic agent, the service/resource request message being implemented in an interface language.

16. A computer implemented method for dynamic agents, the computer implemented method comprising:
executing a plurality of dynamic agents on a plurality of computers connected to a data communications network, the dynamic agents providing application specific functionality, wherein the application specific functionality is dynamically loaded into the dynamic agents

17. The computer implemented method of claim 16 further comprising:
finding a requested application specific program using a resource broker;
dynamically loading the requested application specific program in the first dynamic agent; and
executing the requested application specific program loaded in the first dynamic agent.

18. The computer implemented method of claim 16 further comprising:
cloning the first dynamic agent as a second dynamic agent in the second computer, the first dynamic agent comprising a first network address and a first symbolic name, and the second dynamic agent comprising a second network address and a second symbolic name.

19. The computer implemented method of claim 18 further comprising:
dynamically modifying the second dynamic agent, wherein the second dynamic agent loads a Java™ class.

20. The computer implemented method of claim 16 wherein the agent infrastructure further comprises:
providing a coordinator, the coordinator coordinating cooperative problem solving among a plurality of dynamic agents.

21. The computer implemented method of claim 16 wherein the agent infrastructure further comprises:
providing a resource broker, the resource broker maintaining a directory of registered programs.

22. The computer implemented method of claim 16 wherein the agent infrastructure further comprises:
providing a request broker, the request broker maintaining a request queue.

23. The computer implemented method of claim 16 wherein the agent infrastructure further comprises:
providing an event broker, the event broker classifying events.

24. A computer readable medium comprising dynamic agents for dynamic service provision software, the software comprising:
a plurality of dynamic agents, the dynamic agents comprising an action handler, an agenda handler, a message handler, an open server handler, and a resources handler, the dynamic agent being dynamically modifiable while maintaining its identity and current state information.

25. The computer readable medium as in claim 24 wherein the dynamic agent further comprises:
application specific programs, the application specific programs comprising a Java™ class loaded into an object store of the dynamic agent, the dynamic agent further comprising built-in management services, the built-in management services being used to access resources of the dynamic agent, to activate actions to be performed by the dynamic agent, and to communicate with other dynamic agents.

26. The computer readable medium as in claim 24 wherein the software further comprises:
a coordinator dynamic agent, the coordinator dynamic agent providing a naming service;
a resource broker dynamic agent, the resource broker dynamic agent providing a resource management service;
a request broker dynamic agent, the request broker dynamic agent processing service requests from dynamic agents and forwarding the service requests to appropriate service providers; and
an event broker dynamic agent, the event broker dynamic agent classifying event messages.

27. Computer data signals embodied in a carrier wave comprising:
a service/request message transmitted from one dynamic agent to another dynamic agent, the service/resource request message comprising data, knowledge and action objects, and one or more addresses of other dynamic agents.
